(19) United States
(12) Patent Application Publication
(10) Pub. No.: US 2010/0010739 A1
(43) Pub. Date: Jan. 14, 2010

(54) Route search system, mobile terminal, and route supply server

(75) Inventor: Takao Tsushima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,510

(22) Filed: Sep. 16, 2009

Related U.S. Application Data
(63) Continuation of application No. PCT/JP07/55464, filed on Mar. 19, 2007.

(51) Int. Cl. G01C 21/00

(52) U.S. Cl. 701/209; 701/207; 701/213

(57) ABSTRACT

A route search system includes mobile terminals provided with wireless communications function, and a route supply server. The route supply server includes a route map database that stores a route map; a positional information obtaining section that obtains respective pieces of positional information of the mobile terminals; a point and route calculating section that searches the route map database based on the respective pieces of positional information of the mobile terminals obtained by the positional information obtaining section, and determines a meeting point for users carrying the mobile terminals, respectively, and respective moving routes to the meeting point for the users; and a point and route notifying section that provides notification of the meeting point and each of the moving routes to the meeting point determined by the point and route calculating section to each of the mobile terminals carried by each of the users.

### CROSS-REFERENCE TO RELATED APPLICATION

This is a continuation application of PCT/JP2007/055464, filed on Mar. 19, 2007.

### FIELD

The embodiments discussed herein are related to a route search system in which moving routes are searched for plural users carrying mobile terminals, respectively, to notify the plural users of the searched moving routes, respectively, and a mobile terminal and a route supply server used preferably for the route search system.

### BACKGROUND

Conventionally, there appears on the market a cellular phone mounted with a GPS (Global Positioning System). Since it is possible to detect a geographical position of a cellular phone equipped with the GPS, various kinds of services utilizing the GPS function are considered.

For example, Japanese Laid-open Patent Publication No. 10-148542 discloses a technique that searches a route from a current position of a cellular phone carried by a user to a nearest public traffic station and displays the route.

Further, Japanese Laid-open Patent Publication No. 2001-346246 discloses a technique that notifies a geographical position of a cellular phone carried by a user to other cellular phone carried by a different user.

Meanwhile, Japanese Laid-open Patent Publication No. 11-239379 discloses a method that enables searching of positional information of a cellular phone carried by a specific user from a base station to find the location of the cellular phone, even if the cellular phone is not equipped with the GPS.

However, services that have been provided or proposed so far are limited to use of positional information of a single cellular phone carried by either a user or other user. A wide range of services that comprehensively utilize respective positional information of plural cellular phones has not been considered yet.

### SUMMARY

According to an aspect of the invention, a route search system includes:

plural mobile terminals provided with wireless communications function; and

a route supply server including:
a route map database that stores a route map,
a positional information obtaining section that obtains respective pieces of positional information of the plural mobile terminals,
a point and route calculating section that searches the route map database based on the respective pieces of positional information of the plural mobile terminals obtained by the positional information obtaining section, and determines a meeting point for plural users carrying the plural mobile terminals, respectively, and respective moving routes to the meeting point for the plural users as well, and
a point and route notifying section that provides notification of the meeting point and each of the respective moving routes to the meeting point determined by the point and route calculating section to each of the mobile terminals carried by each of the users.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a conceptual diagram of a route search system that is an embodiment of the present invention;

FIG. 2 is a perspective view of an appearance of one cellular phone representing three cellular phones illustrated in FIG. 1;

FIG. 3 is an internal block diagram of the cellular phone of which outlook is illustrated in FIG. 2;

FIG. 4 is an internal block diagram of a route supply server;

FIG. 5 is a schematic diagram illustrating an example of services to be performed by the route supply system described with reference to FIGS. 1 to 4;

FIG. 6 is a diagram illustrating communications sequence in the route search system illustrated in FIG. 1; and

FIG. 7 is a flowchart of a route supply program run in the route supply server.

### DESCRIPTION OF EMBODIMENTS

Embodiments of the present invention will be described below.

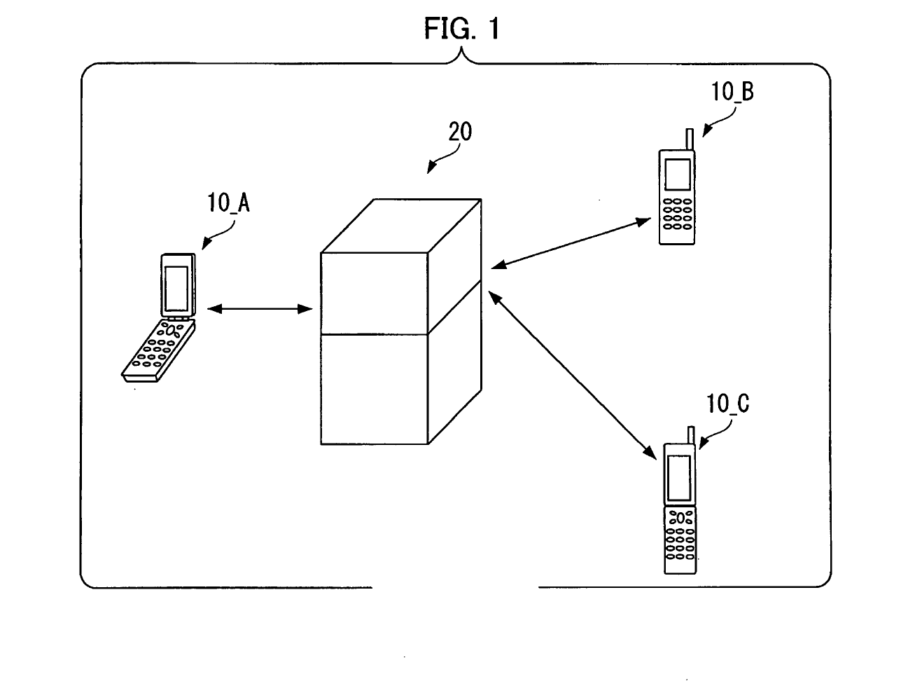

FIG. 1 is a conceptual diagram of a route search system that is an embodiment of the present invention.

In FIG. 1, a route supply server 20 and three cellular phones 10_A, 10_B, and 10_C are illustrated. At least a partial section on the cellular phones 10_A, 10_B, and 10_C side is wirelessly connected to the route supply server 20. In reality, the cellular phones 10_A, 10_B, and 10_C wirelessly communicate to each base station (not illustrated). There are many base stations and Internet networks or the like between each of the base stations and the route supply server 20. However, to simplify the diagram, only elements necessary for describing the present embodiment are illustrated.

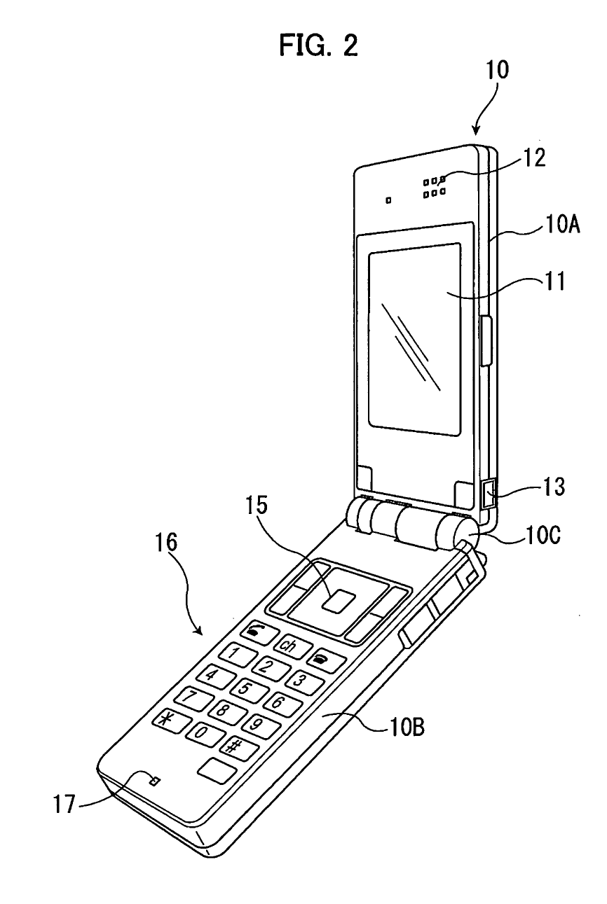

FIG. 2 is a perspective view of an appearance of one cellular phone representing three cellular phones illustrated in FIG. 1.

Ina cellular phone 10 illustrated in FIG. 2, an upper case 10A and a lower case 10B are connected to each other so as to be foldable via a hinge 10C. The upper case 10A is pressed to a user's ear during talk and the lower case 10B is held by the user's hand.

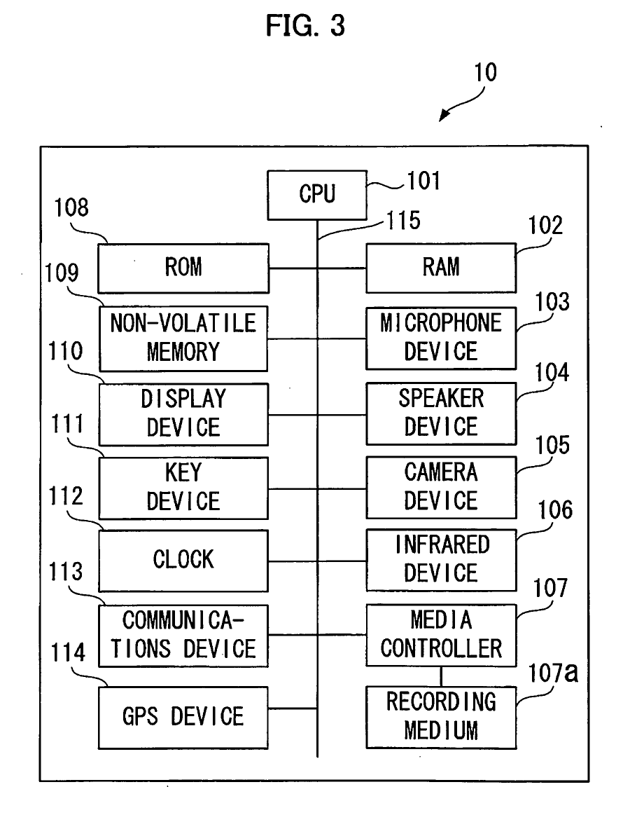

On the upper case 10A, there provided a menu screen, an LCD panel 11 on which a photo image and the like is displayed, an internal speaker (see FIG. 3), an earpiece 12 to output a sound from the speaker. Also, on a side of the upper case 10A, a talk switch 13 is provided that is pressed at the time of talking to use a voice broadcasting function.

On the lower case 10B, there provided a selection button 15 used as a button to select various kinds of functions or used as a shutter button for photographing, a push button to enter phone numbers or the like, an internal microphone (see FIG. 3), and a mouthpiece 17 for sending a voice to the microphone.

Next, internal structure of the cellular phone will be explained.

FIG. 3 is an internal block diagram of the cellular phone of which appearance is illustrated in FIG. 2.

FIG. 3 illustrates a CPU 101, a RAM 102, a microphone device 103, a speaker device 104, a camera device 105, an infrared device 106, a media controller 107, a ROM 108, a non-volatile memory 109, a display device 110, a key device 111, a clock 112, a communications device 113, and a GPS device 114. These elements are connected to one another via a bus 115.

The CPU 101 has a function to run various types of programs and controls the entire cellular phone 10.

The ROM 108 stores the various types of programs and various kinds of constants necessary for the CPU 101 to run the various types of programs. The CPU 101 runs the programs stored in the ROM 108 by using the RAM 102 as a working area.

The non-volatile memory 109 stores various kinds of information that may be possibly overwritten, like address book and received emails.

The microphone device 103 is a microphone to pick up a voice of a user as well as a functional block to process the voice picked up by the microphone.

The speaker device 104 is a speaker to output a voice to the user as well as a functional block to generate a voice signal for driving the speaker.

The camera device 105 is a block to collect image data by photographing. The display device 110 is a block to display an image on the LCD panel 11 (see FIG. 3). The key device 111 is a block to detect various kinds of key operations by the user. The clock 112 is a block to obtain a current time.

The infrared device 106 transmits an image and a telephone number to an external device located in a close range via infrared communications without going through a base station.

The media controller 107 reads data from a mounted recording medium 107a as well as writes image data or the like generated by the camera device 105 into the recording medium 107a.

Further, the communications device 113 realizes a communications function such as talk or packet communications (emailing and so on).

In addition, the GPS device 114 detects geographical location of the cellular phone 10 based on a signal from a satellite.

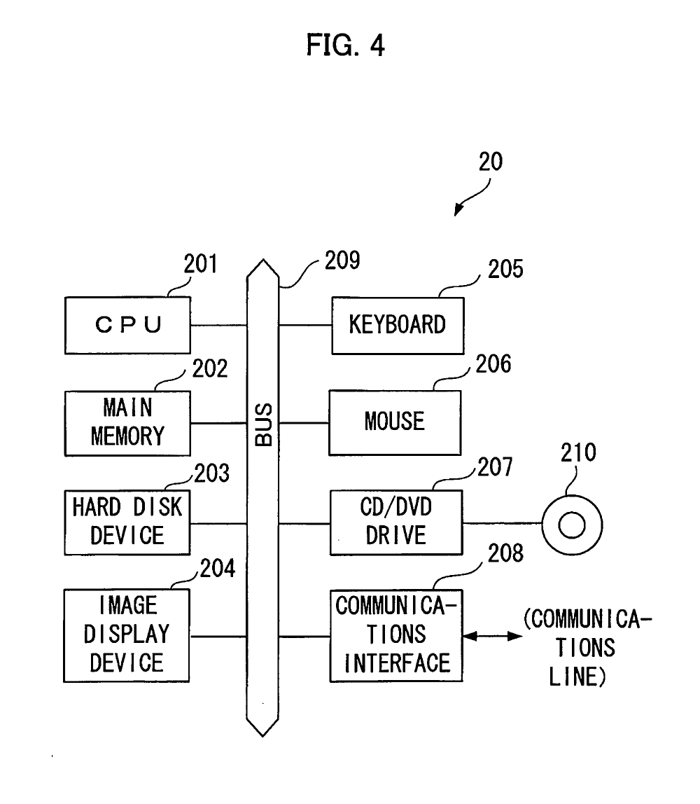

FIG. 4 is an internal block diagram of a route supply server.

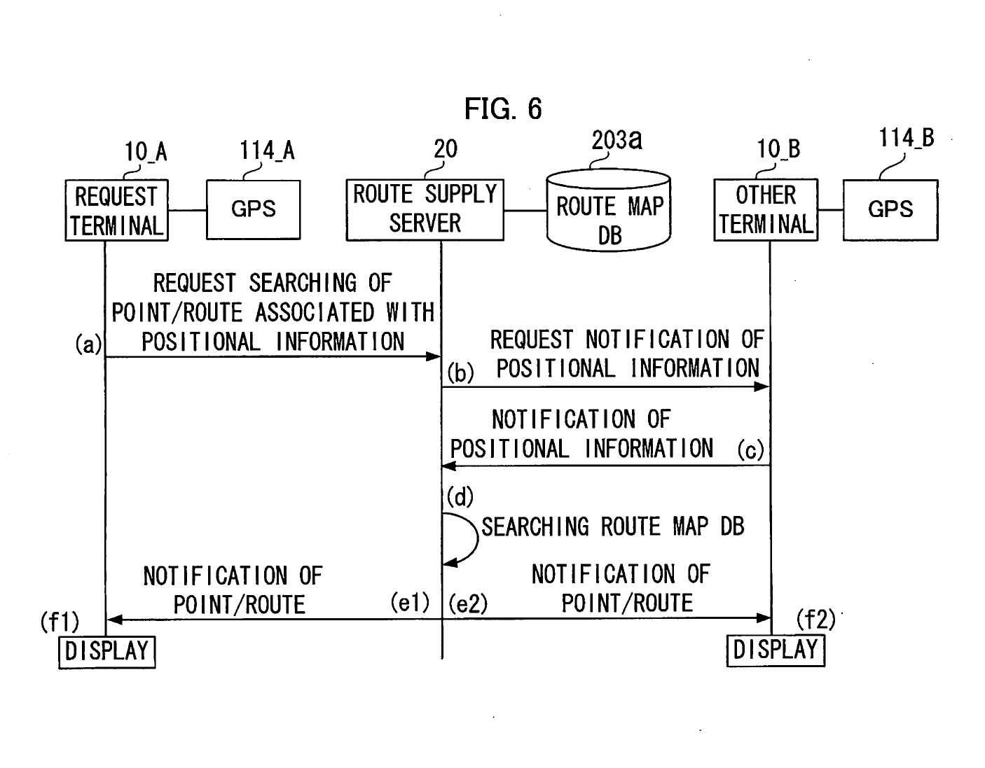

This block diagram is of a general computer. The route supply server includes a computer and a program that is run in the computer and that causes the computer to perform processing illustrated in FIG. 6.

The route supply server 20 illustrated in FIG. 4 is equipped with a CPU 201 that runs various types of programs, a main memory 202 in which a program stored in a hard disk device 203 is read and expanded to be run by the CPU 201, the hard disk device 203 that stores various types of programs and data, a CD/DVD drive 207 which accesses a CD-ROM 210 or a DVD mounted therein, a communications interface 208 that is connected to communications line to communicate with the cellular phones 10_A, 10_B and 10_C illustrated in FIG. 1, and an image display device 204 that displays various kinds of images. All the elements are connected to one another via a bus 209.

In the hard disk device 203, a route map database is constructed. The route map database stores map information associated with latitude and longitude, and a route map including a railroad map such as trains and subways, station names, timetable at each station.

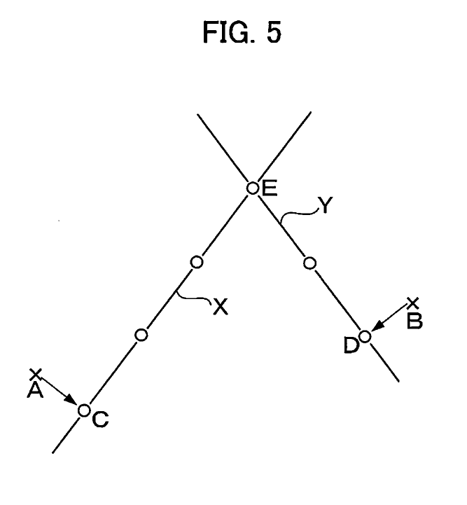

FIG. 5 is a schematic diagram illustrating an example of services to be performed by the route supply system that has been described with reference to FIGS. 1 to 4.

In FIG. 5, two train routes X, Y are illustrated. These two train routes X, Y cross each other at a station E, allowing users to change the line. A user A carrying one cellular phone plans to meet a user B carrying the other cellular phone. Generally, the user A makes a call to the user B or exchanges email with the user B to talk about a meeting place and a meeting time. In this case, however, the meeting will take place to be described below.

FIG. 6 is a diagram illustrating communications sequence in the route search system illustrated in FIG. 1. It is assumed that the users A, B carry the cellular phone 10_A, 10_B, respectively, among the three cellular phones 10_A, 10_B and 10_C. The cellular phones 10_A and 10_B are equipped with GPS devices 114_A and 114_B, respectively (see FIG. 3). In the following, explanation is made about a case in which the user A carrying the cellular phone 10_A requests searching of route. So the cellular phone 10_A is called a request terminal 10_A, and other terminal that is a target of the request is called other terminal 10_B. Additionally, in the route supply server 20, a route map database 203a is constructed in the hard disk device 203 (see FIG. 4).

The user A carrying the request terminal 10_A operates the request terminal 10_A to specify the other terminal 10_B, based on information such as the telephone number, and at the same time obtains positional information of the user A (request terminal 10_A) by using the GPS device 114_A to transmit its positional information to the route supply server 20. In this way, the user A requests the route supply server 20 to search a meeting point with the user B carrying the other terminal 10_B and also a moving route to the meeting point (step a).

Upon receipt of the request, the route supply server 20 notifies the other terminal 10_B of the request from the request terminal 10_A and asks to transmit positional information of the other terminal 10_B (step b). When the other terminal 10_B transmits its positional information to the route supply server 20 in response to the request (step c), the route supply server 20 receives the positional information of the other terminal 10_B and searches the route map database 203a based on the positional information of the request terminal 10_A and the other terminal 10_B to determine a meeting point of the user A and the user B as well as moving routes to the meeting point for the users A and B, respectively (step d). In this case, a station where the user A and the user B can meet in a shortest time is searched for as the meeting point and moving routes to the station are determined for the respective users A and B.

In the example illustrated in FIG. 5, the meeting point is station E. For the user A, a walking route from the current location of the user A to station C nearest from the current location, a train route from the station C to the station E, and estimated arrival time at the station E are obtained. For the user B, a walking route from the current location of the user B to station D nearest from the current location, a train route from the station D to the station E, and estimated arrival time at the station E are obtained.

As a result of searching the route map database in the route supply server 20, when the meeting point and the moving routes of the respective users A and B from the current locations to the meeting point are obtained, the request terminal 10_A is notified of the meeting point and the moving route of the user A which are searched results (step e1), and the other terminal 10_B is notified of the meeting point and the moving route of the user B (step e2). The request terminal 10_A having received the notification displays contents of the notification (step f1), and similarly, the other terminal 10_B having received the notification displays contents of the notification as well (step f2).

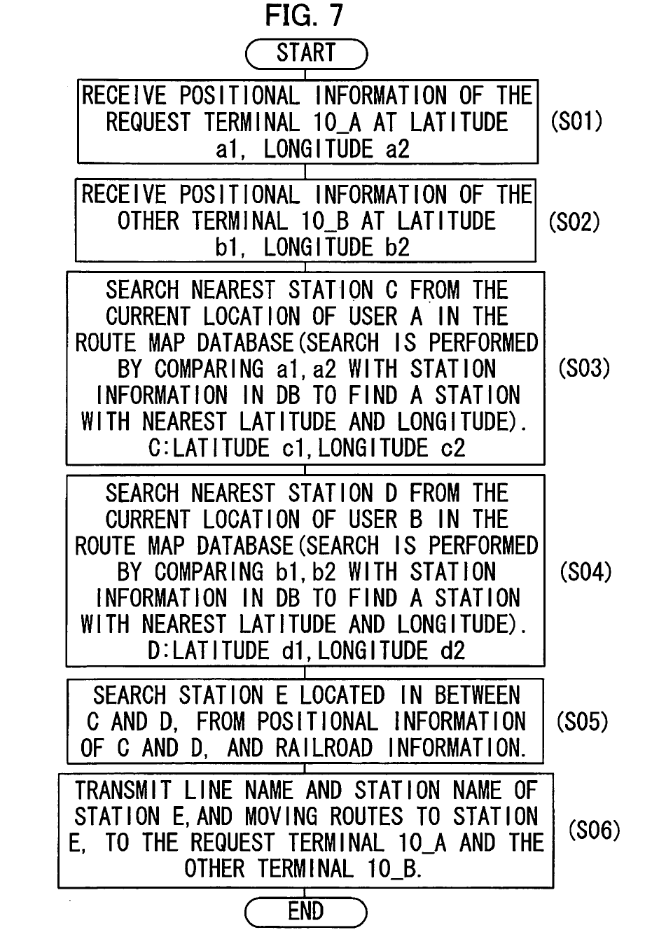

FIG. 7 is a flowchart of a route supply program run in the route supply server 20.

Firstly, positional information of the request terminal 10_A is received (step S01). The current location of the request terminal 10_A is indicated by a latitude a1, a longitude a2.

Secondly, positional information of the other terminal 10_B is received (step S02). The current location of the other terminal 10_B is indicated by a latitude b1, a longitude b2.

Next, in the route map database, station C that is the nearest from the current location of the user A (the request terminal 10_A) is searched for (step S03). In this case, to be more specific, the current location of the request terminal 10_A (latitude a1, longitude a2) is compared with positional information of stations in the database, thereby a station having the nearest latitude and longitude is extracted.

Similarly, in the route map database, station D that is the nearest from the current location of the user B (other terminal 10_B) is searched for (step S04). To be more specific, the current location of the other terminal 10_B (latitude b1, longitude b2) is compared with positional information of stations in the database, thereby a station having the nearest latitude and longitude is extracted.

Thereafter, based on the positional information of the two stations C and D, and railroad information, station E that is located in between these two stations, C and D is found (step S05).

A line name of the station E, a name of the station E, and a moving route to the station E, which have been found in this way are transmitted to the request terminal 10_A and the other terminal 10_B (step S06).

In the above example, between the request terminal 10_A and the other terminal 10_B, a meeting point and moving routes are searched for and notified to these two cellular phones. However, a meeting point and moving routes may be searched for and notified to three and more cellular phones.

Additionally, although in the above description, railroad routes such as train and subway have been used, bus routes and bus stops may also be included.

According to the route search system of the present invention, current positions of plural mobile terminals are obtained, a meeting point is determined for plural users carrying each of the mobile terminals, and the plural users are notified of the meeting point and routes to guide to the meeting point, respectively, thereby providing route guidance that utilizes positional information of the plural mobile terminals comprehensively.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A route search system comprising:
a plurality of mobile terminals provided with wireless communications function; and
a route supply server comprising:
a route map database that stores a route map,
a positional information obtaining section that obtains respective pieces of positional information of the plurality of mobile terminals,
a point and route calculating section that searches the route map database based on the respective pieces of positional information of the plurality of mobile terminals obtained by the positional information obtaining section, and determines a meeting point for a plurality of users carrying the plurality of mobile terminals, respectively, and respective moving routes to the meeting point for the plurality of users as well, and
a point and route notifying section that provides notification of the meeting point and each of the respective moving routes to the meeting point determined by the point and route calculating section to each of the mobile terminals carried by each of the users.

2. The route search system according to claim 1, wherein the route map database stores a route map including point names with positional information and a railroad map that links one point with another point.

3. The route search system according to claim 2, wherein the route map database stores a route map including station names with positional information and a public train map that links one station with another station.

4. The route search system according to claim 1, wherein the mobile terminal includes a GPS function that obtains positional information, and transmits the obtained positional information to the route supply server by using the GPS function.

5. A mobile terminal including wireless communications function, the mobile terminal comprising:
a point and route search request section that specifies a mobile terminal carried by other user and requests searching of a meeting point with the other user carrying the mobile terminal and a moving route to the meeting point, wirelessly to a route supply server that determines a meeting point for a plurality of users carrying a plurality of mobile terminals, respectively, as well as respective moving routes to the meeting point for the plurality of users, and notifies each of the mobile terminals carried by each of the users; and
a point and route notification section that receives the meeting point and the moving routes transmitted from the route supply server, in response to the request by the point and route search request section, and notifies a user carrying the mobile terminal.

6. The mobile terminal according to claim 5, further comprising a GPS function that obtains positional information, and
wherein the point and route search request section notifies the route supply server of positional information obtained by using the GPS function, to request searching of the meeting point and a moving route to the meeting point.

7. A route supply server comprising:
a route map database that stores a route map;
a positional information obtaining section that receives, from a mobile terminal, a request in which other mobile terminal is specified, of searching a meeting point with a user of the other mobile terminal and a moving route to the meeting point, and obtains respective pieces of positional information of the mobile terminal and the other mobile terminal;
a point and route calculating section that searches the route map database based on the respective pieces of positional information of the mobile terminal and the other mobile terminal obtained by the positional information obtaining section, and determines a meeting point of the users carrying the mobile terminal and the other mobile terminal, respectively, as well as respective moving routes to the meeting point for each of the users; and
a point and route notifying section that provides notification of the meeting point and each of the respective moving routes to the meeting point determined by the point and route calculating section to the mobile terminal and the other mobile terminal carried by each of the users.
